(19) United States
(12) Patent Application Publication
(10) Pub. No.: US 2018/0211503 A1
(43) Pub. Date: Jul. 26, 2018

(54) SYSTEMS AND METHODS FOR INTELLIGENT LIGHTING MANAGEMENT WITH SECURITY APPLICATIONS

(71) Applicant: BEON HOME INC., Cambridge, MA (US)

(72) Inventors: Arvind S. Baliga, Lexington, MA (US); Martin FOREST, Arlington, NH (US); Michael DENNINGER, Bedford,, MA (US); Alexei E. ERCHAK, Cambridge, MA (US)

(73) Assignee: BEON HOME INC, Cambridge, MA (US)

(21) Appl. No.: 15/518,067

(22) PCT Filed: Oct. 8, 2015
(86) PCT No.: PCT/US15/54640

§ 371 Date: Apr. 10, 2017

Related U.S. Application Data
(63) Continuation-in-part of application No. PCT/US2014/036307, filed on Jan. 5, 2014.
(60) Provisional application No. 62/061,587, filed on Oct. 8, 2014.
(60) Provisional application No. 61/918,430, filed on Dec. 19, 2013.
(60) Provisional application No. 61/886,446, filed on Oct. 3, 2013.
(60) Provisional application No. 61/818,374, filed on May 1, 2013.

(51) Int. Cl. G08B 15/00; H04L 12/28; G08B 25/00

(52) U.S. Cl. CPC G08B 15/002; G08B 25/008; H04L 12/2816

(57) ABSTRACT

Systems, methods and apparatus are provided for intelligent lighting management with security applications. In some embodiments, the usage of at least one illumination device may be monitored. The illumination device may be a light bulb used in a home. Usage data for the illumination device may be recorded and used to generate a lighting schedule. The lighting schedule may be replayed to simulate occupancy, for example, to deter intruders.

### RELATED APPLICATIONS

This application claims priority under 35 U.S.C. § 119(e) to U.S. Provisional Patent Application Ser. No. 62/061,587, filed Oct. 8, 2014, entitled “Systems and Methods for Intelligent Lighting Management with Security Applications,” and is a continuation-in-part of PCT Application No. PCT/US2014/036307, filed on May 1, 2014, entitled “Modular Illumination Device and Associated Systems and Methods,” which claims priority under 35 U.S.C. § 119(e) to U.S. Provisional Patent Application Ser. No. 61/818,374, filed May 1, 2013, entitled “Modular Illumination Device and Associated Systems and Methods,” U.S. Provisional Patent Application Ser. No. 61/886,446, filed Oct. 3, 2013, entitled “Modular Illumination Device and Associated Systems and Methods,” and U.S. Provisional Patent Application Ser. No. 61/918,430, filed Dec. 19, 2013, entitled “Modular Illumination Device and Associated Systems and Methods.” Each of these applications is incorporated herein by reference in its entirety for all purposes.

### BACKGROUND

Conventional security systems use sensors (e.g., motion detectors) placed throughout a property to detect intruders. When an intruder is detected, the security system sends a notification to the property owner and/or law enforcement.

### SUMMARY

Systems, methods and apparatus are provided for intelligent lighting management with security applications.

In some embodiments, a method for lighting management is provided, comprising acts of: monitoring usage of at least one illumination device; recording usage data for the at least one illumination device; generating a lighting schedule based on the recorded usage data; and playing the lighting schedule generated based on the recorded usage data.

In some embodiments, a method for detecting and responding to a power outage is provided, comprising acts of: detecting at least one first event indicative of a power outage, the at least one first event comprising at least one illumination device losing power; detecting at least one second event indicative of a power outage; determining whether the at least one first event and the at least one second event are no more than a selected length of time apart from each other; and in response to determining that the at least one first event and the at least one second event are no more than the selected length of time apart from each other, initiating at least one power outage response.

In some embodiments, a method for detecting and responding to a potential intrusion is provided, comprising acts of: detecting at least one event indicative of a potential intrusion; and in response to detecting the at least one event indicative of a potential intrusion, initiating a response, the response comprising turning on a first light, a second light, and a third light in sequence.

In some embodiments, a system is provided comprising at least one processor configured to perform any of the above methods. In some embodiments, a computer-readable medium is provided, having stored thereon instructions that, when executed by at least one processor, cause the at least one processor to perform any of the above methods.

### BRIEF DESCRIPTION OF DRAWINGS

FIG. 1A shows an illustrative user interface 150 for lighting management, in accordance with some embodiments.

FIG. 1B shows a portion of the user interface 150 shown in FIG. 1A that can be reached by scrolling.

FIG. 2A shows, schematically, an illustrative lighting management system 200, in accordance with some embodiments.

FIG. 2B shows, schematically, an illustrative lighting management system configured as a module 250, in accordance with some embodiments.

FIG. 3 shows an illustrative process 300 that may be performed by a lighting management system to simulate occupancy, in accordance with some embodiments.

FIG. 4 shows an illustrative process 400 that may be performed by a lighting management system to conserve power, in accordance with some embodiments.

FIG. 5 shows an illustrative process 500 that may be performed by a lighting management system to record usage history, in accordance with some embodiments.

FIG. 6 shows an illustrative process 600 that may be performed by a lighting management system to detect and respond to a power outage, in accordance with some embodiments.

FIG. 7 shows an illustrative process 700 that may be performed by a lighting management system to detect and respond to a potential intrusion, in accordance with some embodiments.

FIG. 8 shows an illustrative hub 102 for an illumination device, in accordance with some embodiments.

FIG. 9 is a front view of the illustrative hub 102 shown in FIG. 8.

FIG. 10 is a top view of the illustrative hub 102 shown in FIG. 8.

FIG. 11 is a cross-sectional view of the illustrative hub 102 shown in FIG. 8, taken along the dash-dot-dash line shown in FIG. 9.

FIG. 12 shows illustrative fittings configured to be mounted in light sockets, suitable for use in various embodiments described herein.

FIG. 13 shows, schematically, an illustrative computer 1000 on which aspects of the present disclosure may be implemented.

### DETAILED DESCRIPTION

The inventors have appreciated several disadvantages of conventional security systems. For instance, a conventional security system may include a large number of sensors per installation and therefore may be costly to purchase and maintain. Furthermore, conventional security systems may produce many false alarms, which may lead to inefficient use of police resources. Further still, the notification generated by a conventional security system may be ineffective in preventing loss, as the intruder may have sufficient time to leave the property before anyone arrives in response to the notification.

The inventors have appreciated that it may be desirable to deter an intruder from entering a property in the first place. The inventors have further appreciated that conventional deterrence methods such as leaving a light on may be ineffective, especially when the light is left on for an extended period of time (e.g., while a home owner goes on vacation), because an intruder may recognize that such a static pattern is inconsistent with normal usage. Although a light timer may be used to turn a light on or off at a specified time, only one schedule may be set with a timer, which may give the intruder a hint that the home may be unoccupied. Furthermore, because different rooms in a home (e.g., bedroom, kitchen, hallway, etc.) may have different usage patterns, multiple timers may be needed with different schedules. It is cumbersome for a user to schedule the timers individually.

In some embodiments, systems and methods are provided for controlling lighting to improve security. For example, lighting may be controlled according to a selected pattern to give the appearance that a property (e.g., a home or commercial establishment) is occupied, so that potential intruders may be discouraged from breaking into the property.

Lighting may be controlled according to any suitable pattern. In some embodiments, one or more lights may be controlled according to a pattern stored in a computer-readable medium, such as a memory. The pattern may represent lighting usage over some period of time (e.g., 24 hours, one week, two weeks, three weeks, one month, etc.)

The stored pattern may be provided in any suitable manner. In one example, the pattern may be programmed by a manufacturer (or an entity in a distribution chain) and stored into a memory of a control device before the control device is distributed to a user. In another example, the stored pattern may be programmed by a user. In another example, the stored pattern may be intelligently learned from usage observations over some period of time (e.g., a few days, weeks, months, or years). Other ways of providing a stored pattern may also be suitable. Furthermore, aspects of the present disclosure relating to lighting control is not limited to the use of a stored pattern. For instance, in some embodiments, one or more lights may be controlled to turn on at a randomly selected time and/or remain on for a randomly selected duration.

In some embodiments, a stored pattern may be dynamically adjusted, for instance, to enhance the appearance of occupancy. In one example, a time at which a light is automatically turned on or off may be adjusted dynamically based on current conditions such as changes in sunrise or sunset time with seasonal progression. For instance, during the winter, a light may be turned off later in the morning to match later sunrise and/or earlier in the evening to match earlier sunset. By contrast, during the summer, the light may be turned off earlier in the morning to match earlier sunrise and/or later in the evening to match later sunset.

In another example, a stored pattern may be adjusted so that at least one light is on at a property during one or more selected periods of time (e.g., morning and/or evening hours, such as between 6 am to sun rise and/or between sunset and 11 pm). Such a light may be selected in any suitable way, such as based on location (e.g., bedroom, kitchen, hallway, etc.) or usage (e.g., the most frequently used light at the property). In another example, a stored pattern may be adjusted such that each light is on for at least a specified duration each day of the week. Other methods for adjusting a stored pattern may also be used, such as allowing a user to make any adjustments (e.g., via a pinch zoom type interface).

A control device may be provided in any suitable manner to control the operation of the illumination device (e.g., a light bulb). In some embodiments, a control device may be a component integrated into an illumination device. In some embodiments, a control device may be a separate device adapted to communicate with, or otherwise control, an illumination device. In some embodiments, a control device may be a module adapted to be assembled with an illumination device. Such a module may be packaged together with, or separately from, the illumination device.

The inventors have appreciated that a non-static pattern of lighting may give a “lived in” appearance that may discourage potential intruders from breaking into a home. The inventors have further appreciated that a pattern learned from actual usage may appear more realistic and therefore may be more effective in deterring potential intruders. In addition, automatically learning usage patterns may improve user experience by reducing the burden imposed on a user. For example, a user may no longer be required to program a pattern explicitly for each individual light (e.g., by creating a different schedule for a bedroom light vs. a kitchen light) via a complex and/or cumbersome user interface.

In some embodiments, usage data for an illumination device (e.g., light bulb) may be collected and analyzed to identify a pattern. The pattern may include any suitable combination of information, such as the amount and/or distribution of usage (e.g., over a period of 24 hours, one week, two weeks, three weeks, one month, etc.). For example, a bulb installed in a bedroom of a home may tend to be used later in the evenings and may be the last to be turned off, whereas a bulb installed in a kitchen may tend to be used earlier in the evenings and may see the most extensive use. However, it should be appreciated that a usage pattern may be recognized and stored for an illumination device without being identified explicitly as corresponding to a particular location (e.g., bedroom, kitchen, hallway, etc.) In some instances, a realistic appearance of occupancy may be achieved when the replayed pattern matches the typical usage at a particular location (e.g., a kitchen light that stays on until around two o'clock in the morning every weeknight), even if the replayed pattern may be considered atypical for a general population.

In some embodiments, a learned pattern may be used in conjunction with a programmed pattern. In one example, a programmed pattern (which may be pre-loaded by a manufacturer or created by a user) may be used initially while usage data is being gathered. Once sufficient usage data has been gathered and analyzed to generate a learned pattern, the programmed pattern may be replaced by the learned pattern. In another example, a programmed pattern may be used as a “seed,” and a learning algorithm may be used to adapt the programmed pattern over time based on collected usage data.

Although some illustrative embodiments are described herein in connection to residential properties, it should be appreciated that aspects of the present disclosure are not limited to use in a home setting. Various techniques described herein may be used in other types of properties such as schools, offices, or other non-residential buildings. Also, it should be appreciated that the techniques described herein relating to learning lighting usage patterns may be used for purposes other than replaying a learned usage pattern to discourage potential intruders from breaking into the property. For example, a learned usage pattern may be used to predict future energy consumption and/or suggest changes to reduce energy consumption.

It should be appreciated that the concepts introduced above and discussed in greater detail below may be implemented in any of numerous ways, as the disclosed concepts are not limited to any particular manner of implementation. The examples shown in the figures and described herein are provided solely for illustrative purposes.

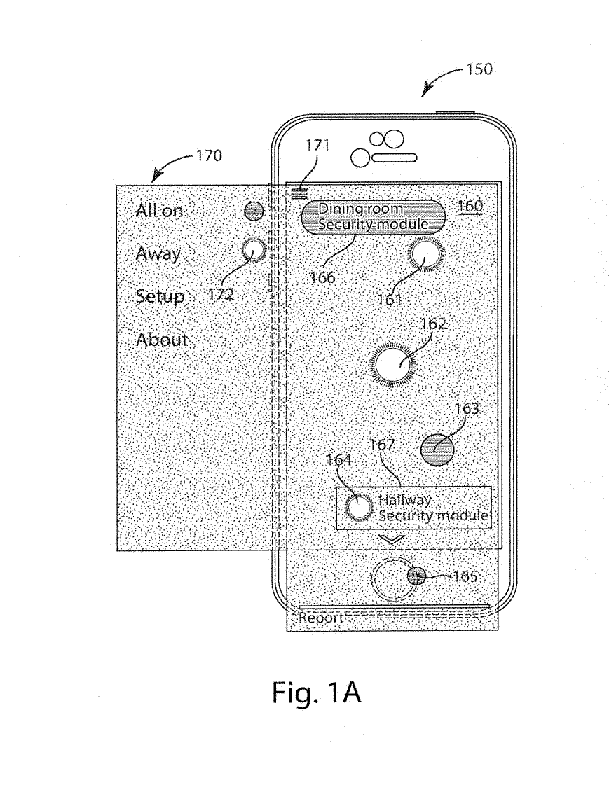

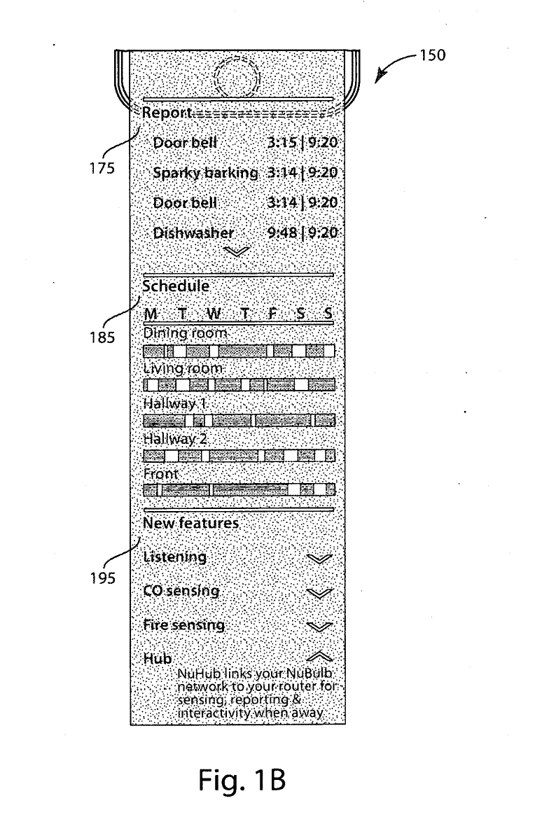

FIGS. 1A-B shows an illustrative user interface 150 for lighting management, in accordance with some embodiments. In this example, the user interface 150 is presented by a software application (also referred to as an “app”) running on a mobile device such as a smartphone. However, it should be appreciated that the user interface may be presented on any computing device, including, but not limited to, a desktop, laptop, or tablet computer.

In the example shown in FIG. 1A, the user interface includes a screen 160 displaying a plurality of indicators, such as spots 161-165. Each of the spots 161-165 may correspond to a different light (or group of lights), and the arrangement of the spots may indicate the physical placement of the corresponding lights. For instance, the spots 161-165 may correspond, respectively, to a dining room light, living room light, first hallway light, second hallway light, and entryway light (which may be located inside or outside). However, it should be appreciated that a graphical representation of the lights is not required, as other types of representation (e.g., a list view) may also be used.

In some embodiments, the manner in which a light is represented may be varied according to one or more attributes associated with the light. In one example, the size of the spot may indicate proximity of the light to a user's current location. In some embodiments, proximity may be measured based on signal strength. For instance, the device on which the user interface 150 is presented may receive a signal (e.g., a Bluetooth® signal) from the light, and the strength of that signal may indicate how close the light is to the user device. Thus, in the example shown in FIG. 1A, the spot 162 may correspond to a light that is located closest to the user device. In another example, the size of a spot may indicate how often the corresponding light is used. For instance, the spot 162 may correspond to a living room light, which may be used more often than the other lights. As a result, the spot 162 may be larger than the other spots. In another example, the brightness of a spot may indicate the current usage of the corresponding light. For instance, the spot 161 may correspond to a dining room light that is currently on, and the spot 161 may be bright. By contrast, the spot 163 may correspond to a hallway light that is currently off, and therefore the spot 163 may be dark. Although not shown in FIG. 1A, a dimmed light may be represented by a similarly dimmed spot on the screen 160.

In some embodiments, additional information about one or more lights may be displayed to a user. For instance, the lights may include different modules for performing different functionalities, and a label may be displayed next to each light to indicate at least one of the light's capabilities. In the example shown in FIG. 1A, a label “dining room security module” is displayed adjacent the spot 161 to indicate that the corresponding dining room light has a security module, which may be capable of listening for events and initiating responses, and a label “hallway speaker module” is displayed adjacent the spot 164 to indicate that the corresponding hallway light has a speaker module, which may be capable of playing sounds such as alarm sounds and/or recorded voice. Other types of modules may also be used, such as a smoke detector module, a carbon monoxide (CO) sensing module, etc.

In the example shown in FIG. 1A, the user interface 150 includes a menu 170 for displaying one or more options to a user. The menu 170 may be brought up in any manner, including, but not limited to, by activating a menu button 171 from the screen 160.

The menu 170 may display any suitable combination of options. In the example shown in FIG. 1A, the menu 170 shows two modes that a user may select—“All on” and “Away.” The “All on” mode may turn on all lights, whereas the “Away” mode may replay a stored pattern to simulate occupancy. In various embodiments, one or both of these modes may be available, as well as any number of other modes. However, it should be appreciated that no particular operating mode is required, nor the use of any operating mode at all.

In some embodiments, the user interface 150 may provide some indication as to whether a particular mode is on. In the example shown in FIG. 1A, a bright spot is displayed to indicate that the “Away” mode is on, while a dark spot is displayed to indicate that the “All on” mode is off. However, it should be appreciated that other types of indicators may also be used, or no indicator at all.

In the example shown in FIG. 1A, the menu 170 also shows two options, “Setup” and “About.” Selecting “About” may bring the user to a help screen for the lighting management application. Selecting “Setup” may bring the user to a separate screen for setting up a new installation. For instance, in some embodiments, selecting “Setup” may launch a setup wizard to guide the user through various setup tasks. In one example, the setup wizard may set up a communication link between the user's device and an illumination device (e.g., a light bulb with a controller and communication interface). In some embodiments, the communication link may be established by performing Bluetooth® pairing, although other communication technologies may be used in addition to, or instead of, Bluetooth®.

FIG. 1B shows a portion of the screen 160 that may be reached by scrolling down. In this example, three sections are displayed—“Report,” “Schedule,” and “New Features.” The “Report” section 175 may include a list of events (e.g., doorbell ringing, dog barking, dishwashing running, etc.) that have been detected and the corresponding times of detection. The “Schedule” section 185 may display, for each light, a corresponding schedule for the light while the “Away” mode is on. For instance, the schedule may be a week-long pattern represented on a horizontal bar, with light-colored portions of the bar representing the time periods during which the light is to be on, and dark-colored portions of the bar representing the time periods during which the light is to be off.

Although a linear representation of time is used in the example of FIG. 1B, it should be appreciated that other types of representations may also be used. For instance, in some embodiments, a linear representation may be used for the days in a week, but within each day a schedule may be presented using a circular representation. The circle may represent any suitable length of time (e.g., 24 hours, 12 hours, 6 hours, etc.). In some embodiments, the circle may represent hours of darkness (e.g., from 6:30 pm to 6:30 am the next morning).

The “New features” section 195 may allow a user to obtain information on features such as listening for events indicative of an intrusion, carbon monoxide (CO) sensing, fire sensing, and network connectivity (e.g., establishing a connection with a wireless hub and communicating with a user device through the wireless hub). For example, in some embodiments, a light may include a microphone for capturing audio signals and a processor programmed to recognize alarm sounds from the captured audio signal. If an alarm sound is “heard” by a light in one part of a home (e.g., the basement), a notification may be sent to a user device. Additionally, or alternatively, all lights in the home may be turned on, and/or an audible warning message may be played. The warning message may be a default message, or a customized message (e.g., recorded by the user).

Although the inventors have appreciated that the user interface features shown in FIGS. 1A-B and described above may be desirable, it should be appreciated that aspects of the present disclosure relating to user interactions are not limited to the use of any of these features.

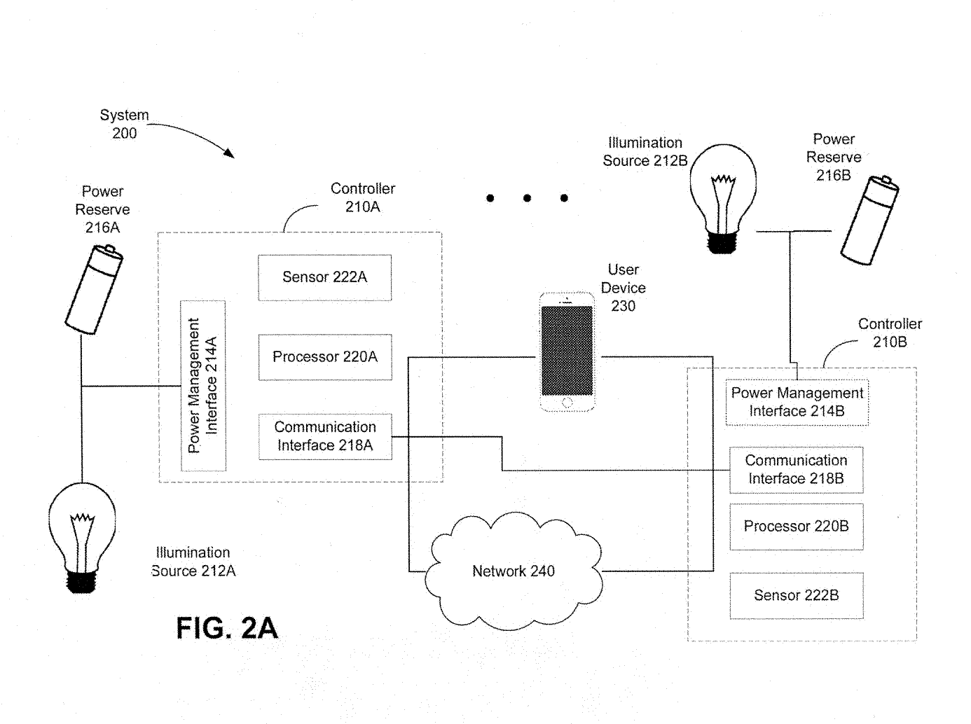

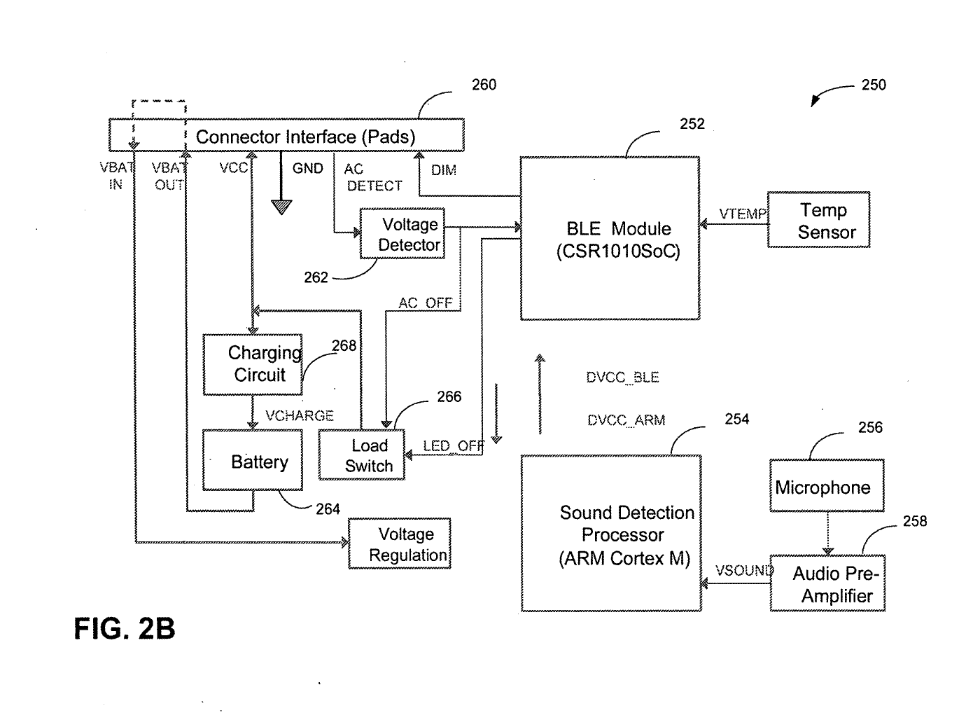

FIG. 2A shows, schematically, an illustrative lighting manage system 200, in accordance with some embodiments. The system 200 may be used, for example, in conjunction with the user interface 150 shown in FIGS. 1A-B to assist a user in managing lighting at a property (e.g., a home).

In the example shown in FIG. 2A, the system 200 includes at least two controllers 210A-B. Each controller may be adapted to control one or more illumination sources (e.g., light bulbs). For instance, the controller 210A may be adapted to manage an illumination source 212A via a power management interface 214A. The power management interface 214A may include circuitry adapted to monitor and/or control one or more aspects of the operation of the illumination source 212A. In one example, the power management interface 214A may be adapted to monitor whether AC power is being supplied to the illumination source 212A. In another example, the power management interface 214A may be adapted to control the brightness of the illumination source 212A, including turning the illumination source 212A on or off.

In some embodiments, the power management interface 214A may also be adapted to manage a power reserve 216A, which may provide power to the illumination source 212A and/or the controller 210A. In one example, the power management interface 214A may be adapted to switch the illumination source 212A from AC power to the power reserve 216A (e.g., during a power outage), and vice versa. In another example, the power management interface 214A may be adapted to determine how much power remains in the power reserve 216A.

In some embodiments, the power reserve 216A may include one or more battery cells. Additionally, or alternatively, the power reserve 216A may include one or more capacitors (e.g., supercapacitors). The battery cells may be rechargeable, and may be recharged while AC power is supplied to the illumination source 212A. Although various advantages of having a power reserve are discussed herein, it should be appreciated that a power reserve is not required, as the controller 201A and/or illumination source 212A may receive only AC power.

In the example shown in FIG. 2A, the controller 210A includes a communication interface 218A, via which the controller 210A may establish communication links with one or more devices, such as a user device 220, network 240 (e.g., via a router, hub, etc.), and/or another lighting controller (e.g., the controller 210B). The communication interface 218A may use any suitable technology or combination of technologies, including, but not limited to, Bluetooth, ZigBee, ANT+, WiFi, and/or Ethernet (e.g., over AC power line).

In some embodiments, the controller 210A may include one or more sensors, such as the sensor 222A shown in FIG. 2A. Any suitable sensor or combination of sensors may be used, including, but not limited to, those adapted to sense ambient conditions (e.g., temperature, humidity, light, sound, etc.), activities (e.g., movement, speech, etc.), and/or hazardous conditions (e.g., smoke, carbon monoxide, etc.). The sensor output may be provided to one or more processors, such as the processor 220A shown in FIG. 2A, which may use the sensor output in any suitable way. In one example, the processor 220A may cause the sensor output to be communicated to another device (e.g., the user device 230 or controller 210B) through the communication interface 218A. In another example, the processor 220A may use the sensor output in managing the illumination source 212A and/or power reserve 216A.

In the example shown in FIG. 2A, the controller 210B manages an illumination source 212B and power reserve 216B, and includes a power management interface 214B, communication interface 218B, processor 220B, and sensor 222B. All of these components may be similar to the counterparts associated with the controller 210A. However, it should be appreciated that different controllers may have different components. For example, the sensors 222A and 222B may be different types of sensors (e.g., the sensor 222A may be a microphone, while the sensor 222B may be a temperature sensor). It should also be appreciated that the processors 220A and 220B may be programmed to perform different functionalities (e.g., the processor 220A may be programmed to detect events indicative of an intrusion and control the lighting to deter the intruder, while the processor 220B may be programmed to detect a hazardous condition and produce an alarm accordingly). Furthermore, it should be appreciated that the system 200 is not limited to having two controllers and may have any number of controllers, including just one controller.

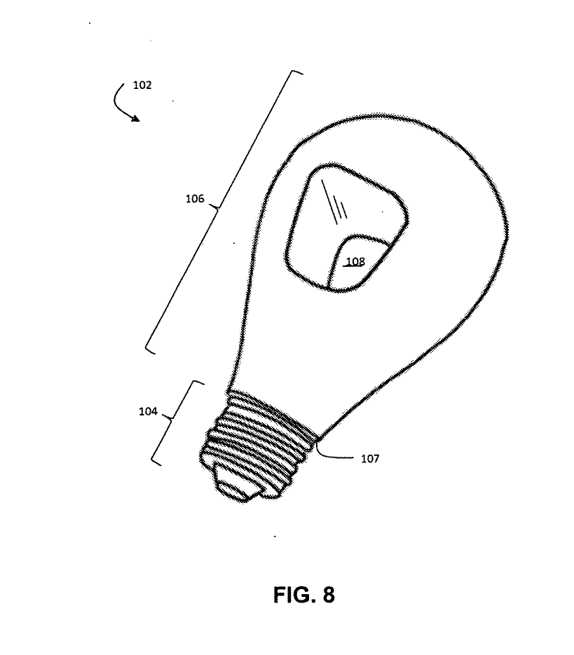

FIG. 2B shows, schematically, an illustrative lighting manage system configured as a module 250, in accordance with some embodiments. The module 250 may be adapted to be assembled with an illumination device, such as the illustrative hub 102 shown in FIG. 8 and described in detail below.

In some embodiments, the module 250 may include a Bluetooth® low energy (BLE) module 252, such as the CSR 1010 processor shown in FIG. 2B. The CSR 101 processor is a system on a chip (SoC) with BLE connectivity. The inventors have appreciated that an SoC processor may provide advantages such as compactness and low energy consumption. However, it should be appreciated that other configurations may also be used, such as a processor and memory with a separate BLE interface.

In some embodiments, the module 250 may additionally include a sound detection processor 254, such as the ARM Cortex M processor shown in FIG. 2B. The sound detection processor 254 may receive, via an audio pre-amplifier 258, audio signals captured by a microphone 256. As discussed in detail below, the sound detection processor 254 may be programmed to recognize one or more sound patterns indicative of a potential intrusion (e.g., an intruder ringing a doorbell or knocking to check if a home is occupied, the sound of a window being smashed, etc.). If such a sound pattern is detected, the sound detection processor 254 may send a notification signal to the BLE module 252, which may cause the BLE module 252 to trigger a lighting pattern to simulate occupancy, for example, by turning on a series of two or more lights in order (e.g., bedroom, then hallway, then entryway) to simulate a person waking up to answer the door or check on a noise.

Although the BLE module 252 and the sound detection process 254 are incorporated into the same module (i.e., the module 250) in the example shown in FIG. 2B, it should be appreciated that, in alternative embodiments, the BLE module 252 and the sound detection processor 254 may be separate. For example, the BLE module 252 may be included in a controller associated with a first light (e.g., in the dining room in a home), while the sound detection processor 254 may be included in a controller associated with a second light (e.g., in a hallway of the same home). In such an embodiment, the sound detection processor 254 may send the notification signal to the BLE module 252 via a BLE interface accessible to the sound detection processor 254.

In the example shown in FIG. 2B, the module 250 includes a connector interface 260 for connecting with an illumination source (not shown). In some embodiments, the connector interface 260 may include a “DIM” line via which the BLE module 252 may control the brightness of the illumination source, including turning the illumination source on or off. The connector may also include an “AC DETECT” line, which may be sampled periodically by a voltage detector to determine whether AC power is being supplied to the illumination source.

In some embodiments, the connector interface 260 may also allow a battery 264 in the module 250 to supply power to the illumination source. For example, if the voltage detector detects that AC power is no longer being supplied to the illumination device, and the BLE module 252 determines that the illumination source is to remain on, a load switch 266 may activate to switch the illumination source to battery power. Additionally, the connector interface 260 may allow the battery 264 to be charged via a charging circuit 268.

In the example shown in FIG. 2B, the module 250 further includes a temperature sensor. In some embodiments, the temperature sensor may be used to monitor the operating temperature of the battery 264 (e.g., to prevent overheating, which may negatively impact battery life). In one example, if the battery is charging and the temperature reaches a certain limit (e.g., 60° C. to 70° C.), the BLE module 252 may stop the charging. In one example, if the battery is being used to power the light and the temperature reaches a similar limit, the BLE module 252 may turn off the light.

Although various details of implementation are shown in FIG. 2B and described above, it should be appreciated that such details are provided merely for purposes of illustration. The inventive concepts described herein are capable of being implemented in numerous other ways.

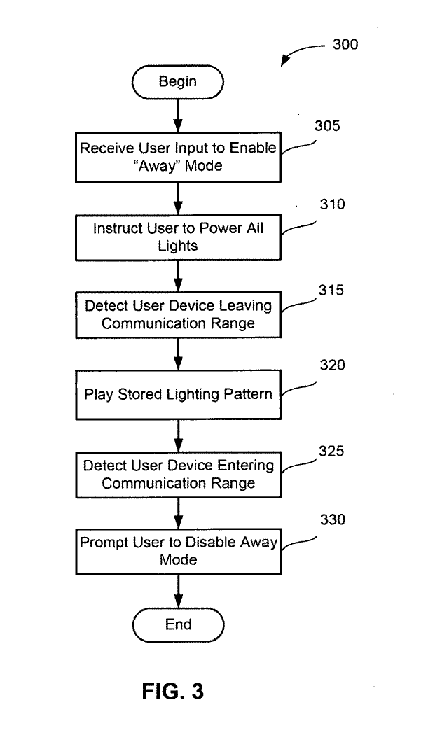

FIG. 3 shows an illustrative process 300 that may be performed by a lighting management system to simulate occupancy, in accordance to some embodiments. For example, the process 300 may be used to prevent burglaries while a home owner is away (e.g., on vacation) for an extended period of time.

In some embodiments, the process 300 may be initiated at act 305 in response to receiving an instruction from a user to enable an “Away” mode of the lighting management system. For instance, the user may use an app (e.g., the illustrative app discussed in connection with FIGS. 1A-B) to manage lighting and may activate the “Away” mode from a menu presented by the app (e.g., the illustrative menu 170 shown in FIG. 1A.) The app may run on any suitable computing device, such as the user's smartphone.

At act 310, the process 300 may instruct the user to switch on all managed lights, so that AC power will be supplied to the lighting management system during the user's absence. In some embodiments, the lighting management system may then monitor whether a device associated with the user (e.g., the smartphone running the app through which the user enabled the “Away” mode) is within communication range. For instance, in some embodiments, the process 300 may be performed by a controller incorporated into a managed light (e.g., as an integral component or a detachable module), and the controller may monitor the presence of the user device using a short-range communication technology (e.g., BLE).

In some embodiments, the lights may remain while the user is still at home, for example, to provide assurance that the “Away” mode has been enabled.

At act 315, the process 300 may detect that the user device has left the communication range. The process 300 may proceed, at act 320, to play a stored lighting pattern (e.g., the illustrative pattern shown in the “Schedule” section 185 of FIG. 1B). In one example, the user may have indicated an expected duration of the absence, and a stored pattern for that duration may be played. In another example, a stored pattern may be played until the user returns. The stored pattern may have a certain length (e.g., one day, two days, . . . , one week, two weeks, . . . , one month, etc.) and may be repeated indefinitely.

In some embodiments, a stored pattern may reflect the usage history of each managed light over the past week, and may be played starting from the beginning of the usage history. Thus, playing the stored pattern may simply be repeating the usage of lighting over the past week. For instance, the user may leave at 7:00 am on a Saturday, and the usage history starting from 7:00 am on the previous Saturday may be played.

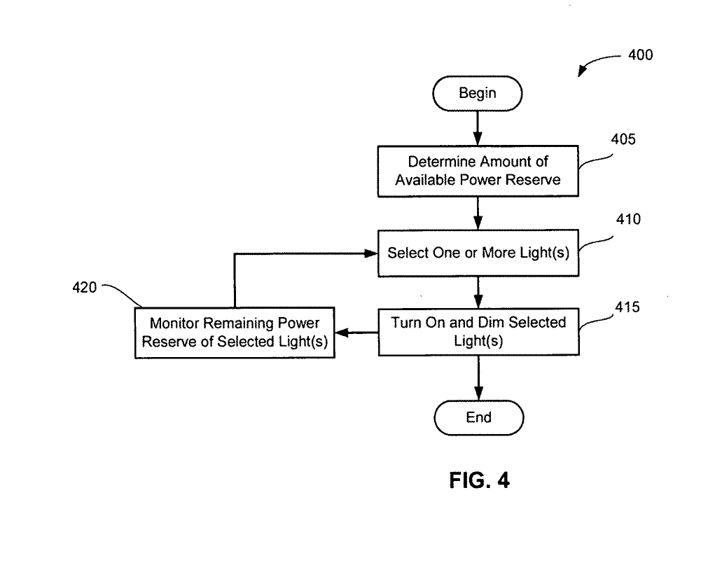

It should be appreciated that the stored pattern may be played at any time after the “Away” mode is enabled. For instance, in some embodiments, the stored pattern may be played as soon as the “Away” mode is enabled, without waiting for the user to leave. Furthermore, the stored pattern may be played even if the user fails to turn on one or more lights, in which case the lighting management system may perform power management (e.g., as described below in connection with FIG. 4).

In some embodiments, the user may enable the “Away” mode remotely using a mobile device via a communication link (e.g., over the Internet) with a local device (e.g., a desktop computer or network hub, or a dedicated gateway for the lighting management system). The local device may in turn communicate with one or more controllers (e.g., the illustrative controllers 210A-B shown in FIG. 2A), for example, using a short-range communication technology such as BLE. In some embodiments, the local device may itself be a controller of a light.

Returning to FIG. 3, the process 300 may, at act 325, detect the user device reentering communication range. In response, the process 300 may, at act 330, prompt the user to disable the “Away” mode, and may disable the “Away” mode when instructed by the user. In some embodiments, the process 300 may wait for some period of time (e.g., 5 minutes, 10 minutes, 15 minutes, . . . , 30 minutes, . . . , one hour, two hours, etc.) before prompting the user, as the user may have returned only for a brief stay.

It should be appreciated that the process 300 may disable the “Away” mode in response to detecting the user device reentering communication range, without prompting the user. For instance, the process 300 may disable the “Away” mode as soon as the user device is detected, and re-enable the “Away” mode when the user device is out of communication range again. This may continue until the user explicitly disables the “Away” mode.

It should also be appreciated that the process 300 may be performed by any suitable device (e.g., mobile phone, desktop, lighting controller, etc.) or combination of devices. For example, one or more of the steps of the process 300 may be performed by the user device (e.g., determining a schedule for each light and transmitting the schedule to a controller associated with the light), while one or more other steps may be performed by a controller associated with a light (e.g., causing the light to turn on or off in autonomous mode, according to a schedule previously loaded into the controller).

Furthermore, in some embodiments, there may be multiple controllers (e.g., one for each light), and one of the controllers may serve as a master controller that performs one or more steps of the process 300, such as directing other lights to be turn on or off. The master controller may be selected in any suitable way. In one example, the mater controller may be the controller associated with the light that is used most frequently, because such a controller may be the most likely to have a high power reserve. However, It should be appreciated that a master controller may be chosen in other ways, such as by the user.

In some embodiments, if the master controller initially selected does not have sufficient power reserve or is otherwise unable to carry out one or more steps of the process 300, another controller may be nominated as a new master. For instance, the controllers may be organized into a logical hierarchy based on frequency of use, and the controller following the current master may be chosen as the new master.

It should be appreciated that the steps of the process 300 shown in FIG. 3 and discussed above are provided solely for purposes of illustration. A lighting management system may perform only a subset of such steps and/or one or more additional steps, or entirely different steps in connection with an “Away” mode. For instance, in some embodiments, the lighting management system may provide a test mode, which may allow the user to play a stored pattern at an accelerated pace (e.g., fast forwarding a one-week schedule in 10 minutes). As the stored pattern is being played, progress may be shown on a time bar for each light, for example, by moving an indicator along the time bar. The time bar may have differently colored portions, with one color representing the time periods during which the light is to be on, and another color representing the time periods during which the light is to be off (e.g., as shown in the “Schedule” section of the illustrative user interface 150 of FIG. 1A).

Moreover, in some embodiments, the process 300 may be initiated without receiving any explicit instructions from the user. In one example, the “Away” mode may be automatically enabled after the user device has been out of communication range for some specified period of time (e.g., 15 minutes, 30 minutes, . . . , one hour, two hours, . . . , 12 hours, etc.). In another example, the “Away” mode may be automatically initiated if no light has been turned on by a certain time (e.g., 9:00 pm in the evening). This start time may be determined in any suitable way. In one example, the start time may be specified by the user (e.g., during a setup phase). In another example, the start time may be determined by analyzing the distribution of the time at which the user turns on a light for the first time each evening (e.g., over a period of one week, two weeks, three weeks, one month, two months, three months, etc.). The start time may be selected so that at least X% of the observed times are before the start time (e.g., using Chebyshev's inequality and the standard deviation of the distribution), where X is specified by the user.

FIG. 4 shows an illustrative process 400 that may be performed by a lighting management system to conserve power, in accordance with some embodiments. For example, the process 400 may be performed when a user enables an “Away” mode without powering one or more lights. The process 400 may also be performed during a power outage.

At act 405, the process 400 may determine the amount of power reserve available for one or more managed lights. Then the process 400 may proceed to act 410 to select one or more lights to be turned on. For instance, the process 400 may select a light with the highest level of remaining power. At act 415, the process 400 may turn on the selected light. To further conserve power, the process 400 may dim the selected light. The brightness level may be selected based on a trade-off between performance and longevity. For example, the brightness level may be the lowest level that is perceivable from outside a home.

At act 420, the process 400 may monitor the level of power remaining at the selected light. When that level drops to a certain threshold, the process 400 may return to act 410 to select one or more other lights to be turned on. In some embodiment, the threshold may be selected so that the remaining power is sufficient to keep the light on for a period of time (e.g., 1 minute, 2 minutes, 3 minutes, 4 minutes, 5 minutes, etc.), for example, to deter an intruder. This processing loop may be repeated until power has been depleted at all lights, or until AC power returns.

It should be appreciated that the lighting management system may use other techniques to conserve power, in addition to, or instead of, the techniques described above in connection with FIG. 4. For instance, if the user enables the “Away” mode without powering on one or more lights, the lighting management may, in some embodiments, reduce the length of time for which a light is turned on each day (e.g., turning on the light later and/or turning off the light earlier) based on the expected duration of absence provided by the user, so that the light will have sufficient power to be turned on in each day during the expected absence. This may result in brightness level higher than the level described above in connection with a power outage.

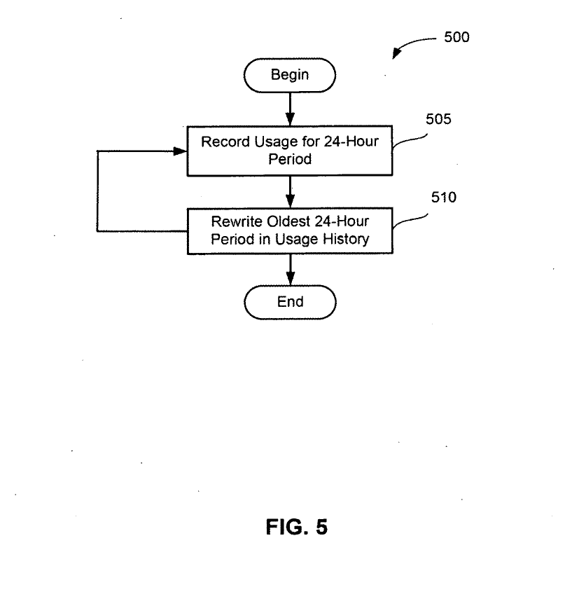

FIG. 5 shows an illustrative process 500 that may be performed by a lighting management system to record usage history, in accordance with some embodiments. A usage history recorded using the process 500 may be used in any suitable way. For example, the usage history may be replayed (e.g., at act 320 of the illustrative process 300) to simulate occupancy when a user turns on an “Away” mode of the lighting management system.

At act 505, the process 500 may record the usage of a light for a certain period of time (e.g., 24 hours). The usage may be recorded in any suitable manner. In some embodiments, a power supply to the light may be monitored. For example, a voltage provided by the power supply and/or current flowing through the light may be sampled at any suitable frequency. Alternatively, or additionally, the monitoring may be perform continuously, and an interrupt may be sent to a processor when a change is detected. The measurements and/or state information derived from the measurements (e.g., a state of the light being “on” or “off”) may be stored. In some embodiments, 14-70 on/off events may be recorded per week for each light. Additionally, or alternatively, a light sensor may be used to determine whether the light has been turned on or off.

At act 510, the usage recorded at 505 may be written into a memory of the lighting management system. In some embodiments, the newly recorded usage may replace the oldest portion of a stored history. For instance, the memory may store a one-week history, and the newly recorded usage, which may be a day long, may replace the oldest one-day period in the stored history. In some embodiments, the old data may be uploaded to another device (e.g., a user's smartphone running a lighting management app) before being replaced.

In some embodiments, a default history may be stored in the memory of the lighting management system. When the lighting management system is first put into use, or if the stored usage history is somehow lost or damaged, a copy of the default history may be made and may be overwritten by the process 500 as the lighting management system is being used.

Furthermore, in some embodiments, the process 500 may fill any “gap” in the recorded usage by having at least one light on (e.g., the light that is most frequently used) in the evening and/or morning hours. For example, the process 500 may adjust the recorded usage before storing it, so that at least one light is on between sunset and 11:00 pm and/or between 6:00 am and sunrise. Alternatively, the recorded usage may be stored without adjustment, but is adjusted when replayed in an “Away” mode.

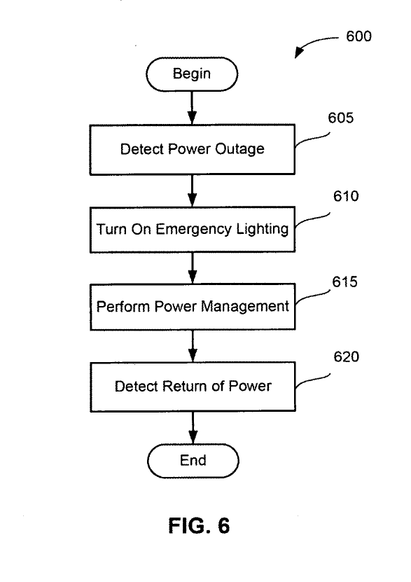

FIG. 6 shows an illustrative process 600 that may be performed by a lighting management system to detect and respond to a power outage, in accordance with some embodiments. At act 605, the process 600 may determine that a power outage has occurred, for example, by detecting that at least two lights lost AC power at about the same time (e.g., within some specified window of time, such as 1 second, 2 seconds, 3 seconds, 4 seconds, 5 seconds, etc.). In some embodiments, the process 600 may check whether the lights that lost power are on the same fixture and determine that a power outage has occurred only if the lights are on different fixtures.

Additionally, or alternatively, the process 600 may determine that a power outage has occurred by detecting that a wireless network or other electrically powered appliance went down at about the same time as a light losing power. The loss of a wireless signal (e.g., a WiFi signal) may be detected in any suitable way. In one example, the loss of WiFi may be detected by a WiFi repeater installed in a light. In another example, a WiFi gateway or mobile device (e.g., the user's smartphone running the lighting management app) may detect the loss of WiFi and may report the loss to one or more lighting controllers (e.g., using BLE).

It should be appreciated that other techniques for detecting power outage may be used in addition to, or instead of those discussed above. For instance, in some embodiments, the process 600 may determine that a power outage has occurred by detecting that a light and a mobile device on a charger lost AC power at about the same time, and/or by detecting that at least two WiFi signals are lost at about the same time. Furthermore, although the inventors have appreciated that the use of multiple checks may reduce the occurrence of false positives, it should be appreciated that only one of the checks discussed above, or another suitable check, may suffice.

Returning to FIG. 6, the process 600 may proceed to act 610 to provide emergency lighting in response to detecting a power outage. For example, if the power outage occurred between sunset (or some specified time in the evening) and sunrise (or some specified time in the morning), the process 600 may turn on all lights (or a subset of lights selected by the user) for a specified period of time (e.g., 5 minutes, 10 minutes, 15 minutes, etc.). This period of time may be set to allow the user to find a flashlight or candle, start a generator, etc.

After the period of emergency lighting, the process 600 may, at act 615, perform power management (e.g., as described above in connection with the illustrative process 500 shown in FIG. 5.) This may continue until the return of power is detected at act 620, at which point the lighting management system may resume normal operation.

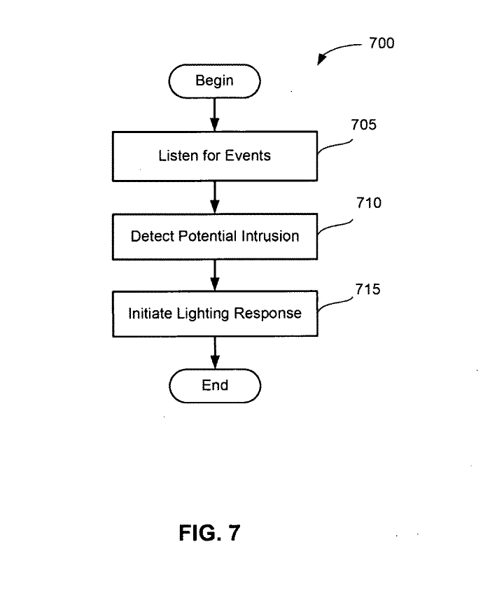

FIG. 7 shows an illustrative process 700 that may be performed by a lighting management system to detect and respond to a potential intrusion, in accordance with some embodiments. For example, the process 700 may be performed when an “Away” mode is enabled to create an illusion that an occupant is moving around in a home, which may deter an intruder from breaking into the home.

At act 705, the process 700 may listen for one or more events indicative of a potential intrusion. The listening may be based on sounds captured by one or more microphones, such as a microphone incorporated into an illumination device or a module adapted to be received by an illumination device. In some embodiments, the microphones may be placed selectively, for example, near a window and/or entryway. Additionally, or alternatively, the listening may be based on a signal from another type of sensor, such as a video camera, an infrared sensor, etc.

The process 700 may analyze the one or more received signals in any suitable way. In some embodiments, an acoustic model may be provided to recognize sounds indicative of a potential intrusion (e.g., doorbell ringing, knock on the door, glass breakage, security siren, etc.). Such an acoustic model may be provided by a manufacturer and/or trained by the user. For instance, a lighting management app may offer a training mode that prompts the user to produce an event to be detected (e.g., by ringing a doorbell and/or knocking on the door). The sounds recorded during training mode may be used to create a new acoustic model and/or adapt an existing acoustic model (e.g., an acoustic model provided by a manufacturer or an entity involved in distribution).

In some embodiments, the user may be prompted to produce the event multiple times (e.g., at least eight times). If some number of the recorded instances (e.g., at least three) are similar (e.g., within a selected threshold distance based on a suitable metric), a template may be created for the event, for example, by averaging the recorded instances that are similar. Confirmation may then be provided to the user that the event has been learned.

In some embodiments, sounds may be analyzed based on their duration and/or frequencies. For instance, glass breakage may produce sounds in a known frequency range that may be unlikely to have come from another source. Furthermore, the sounds associated with glass breakage may have a certain pattern, such as an initial short burst of loud (i.e., high energy) sounds followed by a period of lower energy sounds corresponding to the shards falling and/or a person stepping on the shards. The initial burst may be associated with an object hitting the glass and may have low frequencies (e.g., 200-300 Hz), whereas the following period may have a wider range of frequencies. The captured sounds may be analyzed against this pattern, and/or other patterns, to determine if glass breakage is likely to have occurred.

Returning to FIG. 7, if the process 700 determines at act 710 that a potential intrusion has been detected, the process 715 may proceed to act 715 to initiate one or more lighting responses to deter the intruder. In some embodiments, the lighting response may depend on the time at which the potential intrusion was detected. For example, while an “Away” mode is enabled, the lighting management system may turn on one or more lights during the evening hours (e.g., between 6:28 pm and 11:14 pm) but leave all lights off at night (e.g., after 11:14 pm). Accordingly, a different lighting response may be initiated depending on whether the potential intrusion was detected when one or more lights are on, or when all lights are off.

In some embodiments, if the potential intrusion was detected when all lights are off (e.g., after 11:14 pm), the process 700 may trigger a lighting pattern that includes turning on a sequence of two or more lights in order (e.g., bedroom or any room upstairs in 5 seconds after detection, adjacent hallway in 15 seconds, stairwell in 20 seconds, and entryway in 25 seconds) to simulate a person waking up to answer the door or check on a noise. The sequence may be specified by the user, or may be learned from recorded usage of the lights. For example, a learning algorithm may be used to analyze the recorded usage of multiple lights to identify lights that tend to be turned on (or off) in a particular sequence. The learning algorithm may also be used to identify an interval between the time at which each light is turned on (or off) and the time at which the next light in the sequence is turned on (or off). Alternatively, the timing between each pair of consecutive lights in the sequence may be selected randomly.

In some embodiments, if the potential intrusion was detected when one or more lights are on (e.g., between 6:28 pm and 11:14 pm), the process 700 may trigger a lighting pattern that includes turning off one or more lights and then turning on one or more other lights. For example, one or more lights in a first zone (e.g., kitchen) may be turned off, and then one or more lights in a second zone (e.g., entryway) may be turned on after a suitable delay. The delay may be chosen in any suitable manner to create the illusion that a person is moving from the first zone to the second zone. In one example, the delay may be randomly selected. In another example, the delay may be specified by a user. In another example, the delay may be learned from recorded usage patterns.

In some embodiments, a sound pattern may be played to deter an intruder, in addition to, or instead of, a lighting pattern. In one example, an alarm sound may be played in response to detecting a potential intrusion. In another example, a recorded voice or sound (e.g., dog barking) may be played. In some embodiments, the playback of the recorded voice or sound may be synchronized with the lighting sequence. For instance, the recorded voice or sound (e.g., a chair falling over) may be played in an area where a light has been turned on.

In some embodiments, once a lighting sequence begins, the sequence will be played until completion even if another triggering event is subsequently detected. For example, if a knock on the door triggered a lighting response, the response will continue even if shortly after the knock a window is smashed. Continuing the sequence may match a waking person's behavior better than stopping and restarting the lighting sequence (e.g., stopping the sequence in the hallway and restarting from the bedroom).

In some embodiments, a lighting pattern may include turning off the lights in the sequence in reverse order, which may create the appearance that a person investigated a noise and is returning to the bedroom. There may be a pause (e.g., 10 minutes) after the lights are turned on, before the turn-off sequence is initiated. The length of the pause may be selected in any suitable manner (e.g., by a user or randomly).

In some embodiments, if a first lighting sequence has played until completion and a second lighting sequence is triggered, the second sequence may be altered so that an intruder observing from the outside is less likely to recognize that the lighting sequences are automatically played. For example, the lights being turned on may be different, and/or the intervals between consecutive lights may be altered (e.g., by adding small random delays).

In some embodiments, lights in a home may be organized into zones (e.g., bedroom and/or bathroom, hallway and/or entryway, living room and/or study, dining room and/or kitchen, etc.), and the lighting sequence may be executed on a zone-by-zone basis, rather than a light-by-light basis. For example, when a decision is made to turn on a particular zone, all lights in the zone may be turned on, or one or more lights in the zone may be selectively turned on. The lights may be selected in any suitable manner, for example, at random or by select a light that is used more often than other lights in the zone.

The zones may be specified by a user, for example, during setup of the lighting management system. Alternatively, or additionally, the zones may be learned from usage data. In one example, a learning algorithm may be used to analyze the recorded usage of multiple lights to identify lights that tend to be turned on (or off) at about the same time. In another example, a light may be categorized as belonging to a particular zone based on when and/or how frequently a light is used. For instance, a bedroom light may tend to be used later in the evenings and may be the last to be turned off, whereas a kitchen light may tend to be used earlier in the evenings and may see the most extensive use.

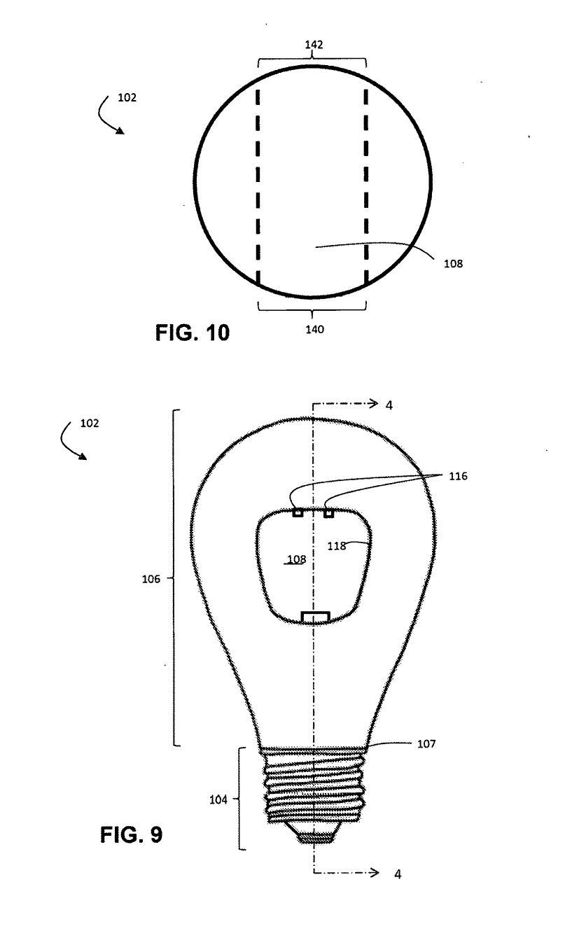

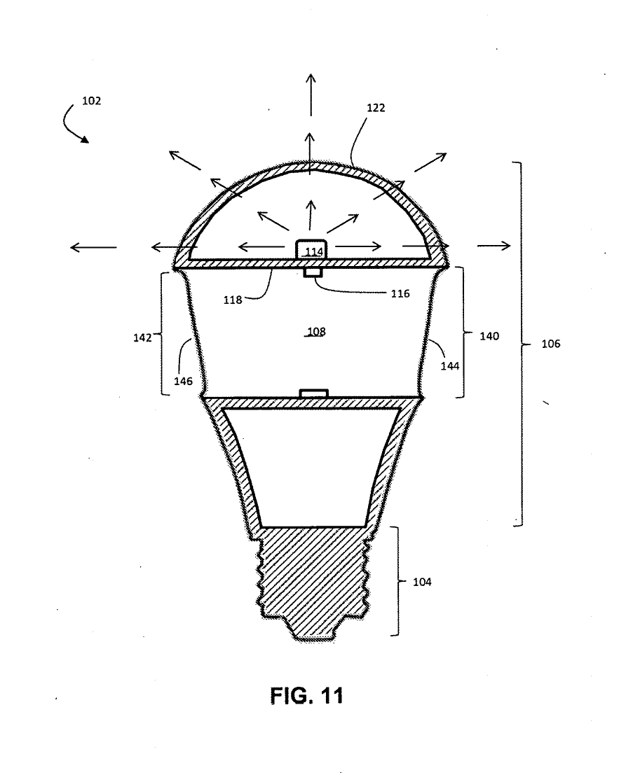

FIG. 8 shows an illustrative hub 102 for an illumination device, in accordance with some embodiments. FIG. 9 is a front view of the illustrative hub 102 shown in FIG. 8. FIG. 10 is a top view of the illustrative hub 102 shown in FIG. 8. FIG. 11 is a cross-sectional view of the illustrative hub 102 shown in FIG. 8, taken along the dash-dot-dash line shown in FIG. 9.

In some embodiments, the hub 102 comprises a fitting configured to be mounted in a light socket. For example, in FIG. 8, hub 102 comprises fitting 104, which is configured to be mounted in a light socket. The fitting may have any suitable form factor that allows the fitting to be mounted in a light socket. For example, in certain embodiments, the fitting of the hub comprises a threaded surface configured to interface with a screw-type socket, such as an Edison socket. One such example is illustrated in FIG. 8, in which fitting 104 comprises a threaded surface. Other types of fittings that can be used (as well as the type of sockets to which the fitting may be configured to be mounted) are described in more detail elsewhere herein. In some embodiments, at least a portion of the fitting is made of an electrically conductive material (e.g., a metal or another electrically conductive material). The fitting may be electrically coupled, according to certain embodiments, to an illumination source of an illumination system (e.g., an illumination source of the hub and/or an illumination source of a module coupled to the hub). In some embodiments, the fitting is electrically coupled to an electronic device of an illumination system (e.g., an electronic device of the hub and/or an electronic device of a module coupled to the hub). In some such embodiments, the fitting can be configured to provide power to one or more electronic devices of the hub and/or one or more electronic devices of a module coupled to the hub. In some embodiments, a buck converter can be electronically coupled to the fitting and an electronic device (e.g., an electronic device of the hub of the illumination system and/or an electronic device of the module of the illumination system). The buck converter can be used, according to certain embodiments, to convert the electronic current received by the fitting of the hub to voltage and/or current level(s) suitable for operation of an electronic device (e.g., within the hub and/or within a module) to which the buck converter is electronically coupled (e.g., a networking component, a power supply charger, or any other electronic device described elsewhere herein).

Referring back to FIG. 8, hub 102 comprises housing 106. The housing of the hub can be connected to the fitting of the hub. For example, in FIG. 8, housing 106 is directly connected to fitting 104 at interface 107. While a direct connection between housing 106 and fitting 104 is illustrated in FIG. 8, indirect connections are also possible. For example, in some embodiments, one or more intermediate structures can be positioned between housing 106 and fitting 104. In certain embodiments, the fitting and the housing are connected such that they cannot be separated from each other without physically damaging the fitting, the housing, or an intermediate material (e.g., an adhesive) positioned between the fitting and the housing.

The housing can be made of any suitable material. In some embodiments, at least a portion of the housing is made of a material that is at least partially transparent to visible light. In certain embodiments, at least a portion of the housing is made of glass and/or plastic.

In certain embodiments, the housing comprises a cavity extending through the housing. The cavity can extend, according to certain embodiments, from a first exterior portion of the housing to a second exterior portion of the housing. For example, referring to FIGS. 10-11, cavity 108 of hub 102 extends from first exterior portion 140 of housing 106 to second exterior portion 142 of housing 106. In some embodiments, the housing comprises a first opening and a second opening, and the cavity within the housing extends from the first opening of the housing to the second opening of the housing. The openings of the housing can expose the interior of the cavity to the environment external to the hub. For example, as illustrated in FIG. 11, cavity 108 extends from first opening 144 of housing 106 to second opening 146 of housing 106. In some embodiments, the cavity can be in the form of a channel extending through the housing of the hub.

The cavity extending through the housing can have any cross-sectional shape. For example, the cross-sectional shape of the cavity can be, according to some embodiments, substantially circular, substantially elliptical, substantially square, substantially rectangular (having any aspect ratio), or irregular. In some embodiments, the cavity is at least partially enclosed by the housing. That is to say, in some embodiments, at least one pathway can be traced along the material of the housing that forms a closed loop around the cavity. In some embodiments, the cavity can be completely enclosed along at least about 50%, at least about 75%, at least about 90%, at least about 95%, or substantially all of its length, with the exception of an opening at the beginning of the cavity and an opening at the end of the cavity. For example, in the embodiments illustrated in FIGS. 8 and 11, cavity 108 is enclosed along its entire length, with the exception of first opening 144 and second opening 146.

As noted above, the use of a cavity extending through the housing between two exterior portions of the housing can allow for relatively easy coupling of a module to the hub. For example, a module can be inserted into a hub by applying a force to a surface of the module, resulting in the module being inserted into cavity 108 of hub 102. In some embodiments, a module that is positioned within the cavity of the hub can be removed from the hub by applying a force against an exposed rear surface of the module.

The hub may be, according to certain embodiments, configured to receive at least one module via an interface of the hub. For example, in certain embodiments, the hub is configured to receive at least one module via the cavity of the hub. The module can be coupled to the hub, for example, by inserting the module into a cavity of the hub such that the module at least partially (or substantially completely) resides within the cavity of the hub. Referring to FIG. 8, for example, hub 102 can be configured to receive a module via cavity 108. The module can be configured to be coupled to the hub, for example, via the cavity of the hub.

The module may, according to certain embodiments, comprise an electronic device. In some embodiments, the electronic device may be configured to perform one or more functions. In certain embodiments, the module is configured to receive an electrical current from and/or transmit an electrical current to the hub. The electrical current transferred between the hub and the module may, in some embodiments, carry an electrical signal. In some such embodiments, and as described in more detail below, the electronic current received by and/or transmitted by the module may be related to one or more electronic functionalities performed by the module (e.g., electronic sensing such as smoke and/or carbon monoxide detection, motion sensing, etc.). In some embodiments, the module can be electrically coupled to the fitting of the hub (e.g., fitting 104 in FIG. 8). This can be achieved, for example, by establishing electrical couplings between the module and the hub, as described in more detail elsewhere herein.

In some embodiments, the module has a relatively large volume. For example, in certain embodiments, the module occupies a volume of at least about 13 cm³, at least about 20 cm³, or at least about 25 cm³ (and/or, in some embodiments, up to about 60 cm³, or more). The use of modules with relatively large volumes can be advantageous, according to certain embodiments, as such modules can be easier to handle. For example, relatively large modules may be easier to pick up, add to hubs, and/or remove from hubs.

Some embodiments relate to illumination systems comprising a hub and a module coupled to the hub via a physical interface. For example, the module may be coupled to the hub via a cavity in the hub (e.g., cavity 108 in FIG. 8).

In some embodiments, the hub and module can be coupled to form a unitary body having a substantially smooth surface formed between the hub and the module. That is to say, in some embodiments, when the hub and module are coupled to form a unitary body, the external surfaces of the hub and module can be aligned such that there are no substantial discontinuities formed between the hub and the module.

In some embodiments, an physical interface between a hub and a module(s) may comprise at least one air inlet and/or at least one air outlet. The air inlet(s) and/or outlet(s) can be configured such that modules that utilize air flow have mechanical features that provide access upon insertion. In some embodiments, air inlet(s) and/or outlet(s) between the hub and any modules that do not require airflow may remain closed upon connecting the modules to the hub.

According to certain embodiments, the hub comprises at least one connection configured to send an electrical current to and/or receive an electrical current from a module. In some embodiments, the electrical current received by the hub from the module and/or the electrical current transmitted from the hub to the module carries an electrical signal. In some embodiments, an electrical current transferred from the hub to the module is used to provide power to the module (e.g., to power any of the electronic devices within the module described herein). In certain embodiments, an electrical current transferred from the module to the hub is used to provide power to the hub (e.g., to power any of the electronic devices within the hub described herein).

The electrical connection between the hub and the module may be a wireless connection and/or a wired connection. In some embodiments, the hub and/or the module comprises at least one electrical contact. The electrical contact of the hub may be configured to receive an electrical current from and/or transmit an electrical current to the module. The electrical contact of the module may be configured to receive an electrical current from and/or transmit an electrical current to the hub. Referring to FIG. 11, for example, hub 102 can comprise at least one electrical contact 116 (e.g., an electrical contact pad, such as a metallic electrical contact pad). The electrical contact can be made of any suitable electrically conductive material. For example, in some embodiments, at least a portion of the electrical contact (e.g., of the hub and/or of the module) is formed of a metal.

In certain embodiments, when the module and the hub are assembled, an electrical contact of the module is electrically coupled to an electrical contact of the hub. For example, in certain embodiments, when a module is assembled with hub 102, electrical contact of the module can be aligned with electrical contact 116 of hub 102 such that electrical current can be transported between hub 102 and the module.

In certain embodiments, the electrical contact(s) of the hub can be located within the cavity of the hub (e.g., on an exposed surface of the cavity, when the cavity is not housing a module). For example, referring to FIG. 11, electrical contacts 116 of hub 102 are located on surface 118 of cavity 108.

In certain embodiments, the electrical current transferred between the hub and the module can carry an electrical signal. The electrical signal can, in some embodiments, be received by a processor (e.g., a microprocessor) associated with the hub and/or the module. In some embodiments, the hub can provide electrical current to the module, via contact(s) 116, to at least partially power at least one electronic device (e.g., a microprocessor, a sensor, a wireless transmitter and/or receiver, etc.) of the module. In some embodiments, the electrical contact(s) of the hub is electrically coupled to the fitting of the hub. For example, referring to FIG. 11, in some embodiments, electrical contact 116 is electrically coupled to fitting 104. For example, a wire, electric trace, or other electrically conductive connector can establish contact between the electrical contact and the fitting. In some such embodiments, at least a portion of the electrical current received by the fitting (e.g., via a light socket) can be used to power an electronic device of a module coupled to the hub.

In some embodiments, the hub comprises an illumination source. The illumination source can be configured to emit visible light (e.g., light having at least one wavelength between about 390 nm and about 700 nm).

The illumination source can be contained within or otherwise associated with the housing of the hub in any suitable fashion. In some embodiments, the illumination source is at least partially enclosed by the housing. For example, referring to FIG. 11, illumination source 114 is contained within an enclosed volume of housing 106.

The illumination source can be electrically coupled to the fitting of the hub. For example, in FIG. 11, illumination source 114 can be electrically coupled to fitting 104 of hub 102. The electrical coupling can comprise, for example, an electrically conductive wire, trace, or other electrically conductive pathway between the illumination source and the fitting of the hub.

In certain embodiments, the illumination source is positioned near an end of the hub (e.g., an end opposite the fitting of the hub that is configured to be mounted in a light socket). For example, the illumination source can be positioned, in some embodiments, near the top portion of the hub and/or the unitary body formed by the hub and any modules connected to the hub. In some embodiments, the cavity of the hub (e.g., cavity 108 in FIG. 8) can be located between the illumination source and the fitting of the hub that is configured to be mounted in a light socket. The illumination source can also be located in other areas of the hub. For example, in some embodiments, one or more illumination sources can be positioned on one or more side portions of the hub and/or the unitary body formed by the hub and any modules connected to the hub (in addition to or in place of an illumination source positioned near an end of the hub and/or the unitary body formed by the hub).

According to certain embodiments, the illumination source and the hub are assembled such that removal of the illumination source requires separate steps of removing at least a portion of the housing (e.g., an exterior casing defined by the housing) of the hub and removing the illumination source from the hub. For example, in some embodiments, illumination source 114 in FIG. 11 cannot be removed from hub 102 without first removing top portion 122 of housing 106.

In some embodiments, the illumination source is configured such that the hub (and/or the combination of the hub and one or more modules) emits light at a luminous flux of at least about 375 lumens, at least about 450 lumens, at least about 600 lumens, or at least about 800 lumens (and/or, in some embodiments, up to about 2000 lumens, up to about 3000 lumens, up to about 6200 lumens, or more). One of ordinary skill in the art is capable of determining the luminous flux emitted by an illumination source using, for example, an integrating sphere. The illumination source may be used, for example, in a general lighting application. For example, in certain embodiments, the hub and illumination source may be used to replace a traditional light bulb. According to certain embodiments, the illumination source may emit smaller amounts of light. For example, in some embodiments, the illumination source is configured such that the hub (and/or the combination of the hub and one or more modules) emits light at a luminous flux of at least about 20 lumens, at least about 50 lumens, at least about 100 lumens, or at least about 200 lumens (and/or, in some embodiments, less than or up to about 375 lumens, less than or up to about 2000 lumens, less than or up to about 3000 lumens, or less than or up to about 6200 lumens). Illumination sources having a luminous flux of less than 20 lumens could also be used.

Any suitable type of illumination source can be used in association with the illumination systems and components described herein. In some embodiments, the illumination source is an omnidirectional illumination source. For example, in FIG. 11, illumination source 114 is illustrated as being an omnidirectional source, as light (indicated by arrows extending our from source 114) is emitted in substantially all directions. The use of omnidirectional sources is not required, however, and in other embodiments, the illumination source can be a directional illumination source.

In some embodiments, the illumination source is a solid-state illumination source. For example, in some embodiments, the illumination source comprises one or more light-emitting diodes (LEDs). Color and/or white LEDs can be used, according to certain embodiments. The use of a solid-state illumination source (such as LEDs) in association with the hub (and/or module) can allow one to more easily integrate the hub (and/or module) with other solid-state components (e.g., solid-state sensors or any of the other solid-state components described herein). However, the illumination sources described herein are not limited to those comprising an LED, and in certain embodiments, other, non-solid-state illumination sources (e.g., incandescent sources, HID sources, fluorescent sources, etc.) can be used as illumination sources.

The illumination source can include a single light-emitting unit multiple light-emitting units. For example, in some embodiments, multiple light-emitting units can be used to create a light pattern (e.g., a specified beam pattern).

In some embodiments in which the hub comprises a solid-state illumination source(s) (e.g., an LED illumination source), additional electronics may be incorporated with the hub, such as a metal-core printed circuit board (MCPCB), driver, and/or controller electronics.

While embodiments in which the illumination source is coupled to the hub are primarily described, in other embodiments, the illumination source could be coupled to the module (in addition to or in place of an illumination source coupled to the hub associated with the module). The illumination source coupled to the module can have any of the properties of illumination sources coupled to the hub, as described elsewhere herein.

As noted above, the hub comprises, in some embodiments, a fitting that is configured to be connected to a light socket. The fitting may be configured, according to certain embodiments, to provide electrical current to any electronic device of the hub and/or to the electrical contact(s) of the hub that are configured to interface with the electrical contact(s) of the module. In some embodiments, the fitting of the hub is configured to provide electrical current to a module (and, in some cases, any electronic device of the module) when the module is coupled with the hub.

In some embodiments, the fitting of the hub is configured to connect to existing sockets (e.g., ceiling-mounted light sockets) in existing lighting electrical infrastructure. This can be achieved, for example, by including on the hub a physical interface that is identical or similar to the physical interface included in the existing socket. Examples of such connections include, but are not limited to, E26 connections, E27 connections, and the like.

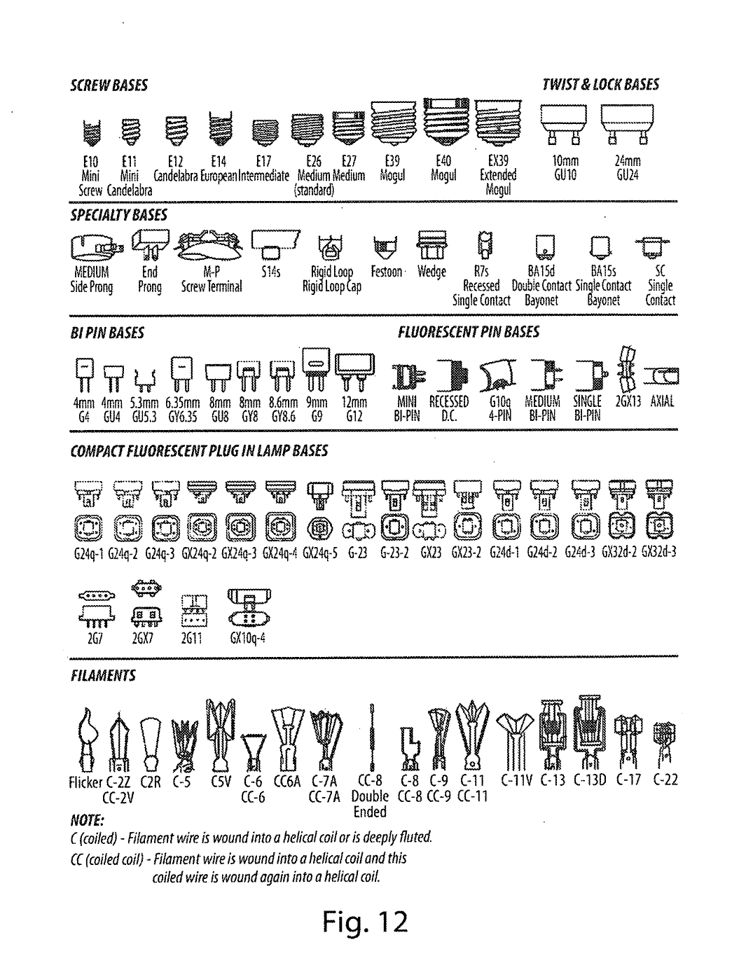

In certain embodiments, the hub comprises a screw-type fitting (e.g., an E10 (“mini screw”) fitting, E11 (“mini candelabra”) fitting, E12 (“candelabra”) fitting, E14 (“European”) fitting, E17 (“Intermediate”) fitting, E26 fitting, E27 fitting, E39 fitting, E40 fitting, EX39 fitting, and the like), a twist and lock fitting (e.g., a GU10 fitting , GU24 fitting, and the like), a bayonet style fitting (e.g., a B15 fitting, a B22 fitting, and the like), a BI pin type fitting, a fluorescent pin type fitting, a compact fluorescent type fitting, or a filament type fitting. In some embodiments, the fitting comprises an Edison fitting. Specific examples of fitting types that may be used are shown, for example, in FIG. 12.

In some embodiments, the light socket to which the fitting on the hub is configured to be mounted comprises at least one of a thread-type socket (e.g., a socket configured to receive an E10 (“mini screw”) connection, E11 (“mini candelabra”) connection, E12 (“candelabra”) connection, E14 (“European”) connection, E17 (“Intermediate”) connection, E26 connection, E27 connection, E39 connection, E40 connection, EX39 connection, and the like), a twist and lock socket (e.g., a socket configured to receive a twist and lock base, such as a GU10 connection, GU24 connection, and the like), a BI pin type socket, a fluorescent pin type socket, a compact fluorescent type socket, a bayonet style socket, or a filament type socket. In some embodiments, the light socket to which the fitting on the hub is configured to be mounted comprises an Edison socket.

In some embodiments the hub (or the combination of hub and module) is substantially in the shape of conventional light bulbs such as recessed lighting bulbs (e.g., PAR 20, PAR 30, PAR 38 bulbs, etc.) or general service bulbs (e.g., incandescent Type A bulbs that may be used for example in table or floor lamps). In certain embodiments, the form factor of the hub (or the combination of hub and module) can correspond to a standard ANSI configuration, such as an A-series light bulb (e.g., A19) form factor, or the like. In some embodiments, the hub (or the combination of the hub and module) is in the shape of an A series light bulb (e.g., A-15, A-19, A-21, A 23, and the like), a B series light bulb (e.g., B-8, B-10, and the like), a C-7/F series light bulb (e.g., C-7, C-9, C-11, C-15, and the like), a CA series light bulb (e.g., CA-8, CA-10, and the like), an S series light bulb (e.g., S-6, S-8, S-11, S-14, and the like), an F series light bulb (e.g., F-10, F-15, F-20, and the like), an RP series light bulb (e.g., RP-11 and the like), an MB series light bulb (e.g., MB-19 and the like), a BT series light bulb (e.g., BT-15 and the like), an R series light bulb (e.g., R-12, R-14, R-16, R-20, R-25, R-30, R-40, and the like), an MR series light bulb (e.g., MR-8, MR-11, MR-16, MR-20, and the like), a PS series light bulb (E.g., PS-25, PS-30, PS-35, and the like), an AR series light bulb (e.g., AR-70, AR-111, and the like), an ALR series light bulb (e.g., ALR-37, ALR-56, and the like), a BR series light bulb (e.g., BR-25, BR-30, BR-38, BR-40, and the like), a PAR series light bulb (e.g., PAR-16, PAR-20, PAR-30S, PAR-30L, PAR-36, PAR-38, PAR-46, PAR-56, PAR-64, and the like), a Linestra-type bulb (e.g., T-10 2-base, T6½, T-8, T, JCD, JC, T-tungsten halogen double ended, and the like), a T series light bulb (e.g., T-4, T-4½, T-5½, T-6, T-6½, T-7, T-8, T-10, and the like), a G series light bulb (e.g., G-16½, G-25, G-30, G40, and the like), a BT series light bulb (e.g., BT-28, BT-37, BT-56, and the like), an E series light bulb (e.g., E-17, E-18, E-23½, E-23, E-37, E-25, and the like), an ED series light bulb (e.g., ED-17, ED-18, ED-23½, ED-28, and the like), and/or any form factor used in recessed light fixtures (e.g., LR4, LRS, LR6, CR4, CR5, and/or CR6). New aesthetic designs may also be used.

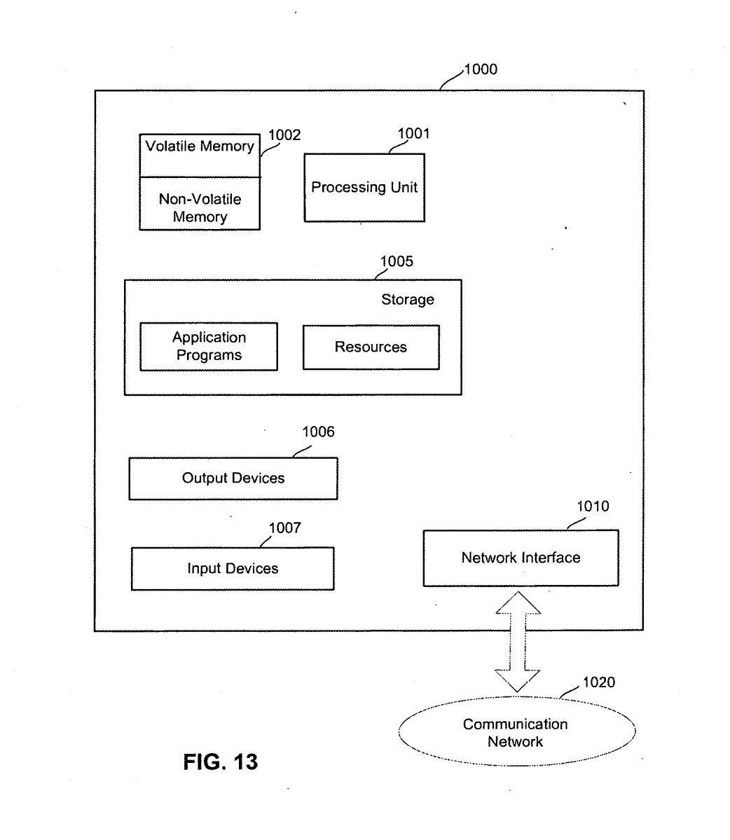

FIG. 13 shows, schematically, an illustrative computer 1000 on which any aspect of the present disclosure may be implemented. For example, the computer 1000 may be a mobile device on which any of the features described in connection with the illustrative user device 230 shown in FIG. 2A may be implemented. The computer 1000 may also be used in implementing a desktop computer or some other component of a system in which any of the concepts described herein may be implemented.

As used herein, a “mobile device” may be any computing device that is sufficiently small so that it may be carried by a user (e.g., held in a hand of the user). Examples of mobile devices include, but are not limited to, mobile phones, pagers, portable media players, e-book readers, handheld game consoles, personal digital assistants (PDAs) and tablet computers. In some instances, the weight of a mobile device may be at most one pound, one and a half pounds, or two pounds, and/or the largest dimension of a mobile device may be at most six inches, nine inches, or one foot. Additionally, a mobile device may include features that enable the user to use the device at diverse locations. For example, a mobile device may include a power storage (e.g., battery) so that it may be used for some duration without being plugged into a power outlet. As another example, a mobile device may include a wireless network interface configured to provide a network connection without being physically connected to a network connection point.

In the example shown in FIG. 13, the computer 1000 includes a processing unit 1001 having one or more processors and a non-transitory computer-readable storage medium 1002 that may include, for example, volatile and/or non-volatile memory. The memory 1002 may store one or more instructions to program the processing unit 1001 to perform any of the functions described herein. The computer 1000 may also include other types of non-transitory computer-readable medium, such as storage 1005 (e.g., one or more disk drives) in addition to the system memory 1002. The storage 1005 may also store one or more application programs and/or resources used by application programs (e.g., software libraries), which may be loaded into the memory 1002.

The computer 1000 may have one or more input devices and/or output devices, such as devices 1006 and 1007 illustrated in FIG. 13. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 1007 may include a microphone for capturing audio signals, and the output devices 1006 may include a display screen for visually rendering, and/or a speaker for audibly rendering, recognized text.

As shown in FIG. 13, the computer 1000 may also comprise one or more network interfaces (e.g., the network interface 1010) to enable communication via various networks (e.g., the network 1020). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer readable medium or media can be transportable, such that the program or programs stored thereon can be loaded onto one or more different computers or other processors to implement various aspects of the present disclosure as discussed above.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A method for lighting management, comprising acts of:
monitoring usage of at least one illumination device;
recording usage data for the at least one illumination device;
generating a lighting schedule based on the recorded usage data; and
playing the lighting schedule generated based on the recorded usage data.

2. The method of claim 1, wherein the act of playing the lighting schedule comprises controlling the at least one illumination device based on the lighting schedule.

3. The method of claim 1, wherein the act of playing the lighting schedule is performed in response to receiving an instruction from a user.

4. The method of claim 3, further comprising an act of:
in response to the instruction from the user to play the lighting schedule, prompting the user to power the at least one illumination device.

5. The method of claim 1, wherein the act of playing the lighting schedule is performed in response to detecting an absence of a user.

6. The method claim 5, wherein the act of playing the lighting schedule is initiated when the user has been absent for a certain period of time.

7. The method claim 6, wherein the act of playing the lighting schedule is initiated when the user has been absent for 30 minutes.

8. The method of claim 5, wherein detecting the absence of the user comprises detecting that a device of the user is not in communication range.

9. The method of claim 1, further comprising an act of:
in response to detecting a presence of a user followed by a period of absence of the user, prompting the user to provide an instruction to stop playing the lighting schedule.

10. At least one computer-readable medium having stored thereon instructions which, when executed by at least one processor, cause the at least one processor to perform a method for lighting management, the method comprising acts of:
monitoring usage of at least one illumination device;
recording usage data for the at least one illumination device;
generating a lighting schedule based on the recorded usage data; and
playing the lighting schedule generated based on the recorded usage data.

11. A system comprising at least one processor configured to perform a method for lighting management, the method comprising acts of:
monitoring usage of at least one illumination device;
recording usage data for the at least one illumination device;
generating a lighting schedule based on the recorded usage data; and
playing the lighting schedule generated based on the recorded usage data.

12. A method for detecting and responding to a power outage, comprising acts of:
detecting at least one first event indicative of a power outage, the at least one first event comprising at least one illumination device losing power;
detecting at least one second event indicative of a power outage;
determining whether the at least one first event and the at least one second event are no more than a selected length of time apart from each other; and
in response to determining that the at least one first event and the at least one second event are no more than the selected length of time apart from each other, initiating at least one power outage response.

13. The method of claim 12, wherein the at least one illumination device is a first illumination device, and wherein the second event indicative of a power outage comprises a second illumination device losing power.

14. The method of claim 12, wherein the second event indicative of a power outage comprises a wireless network becoming unavailable.

15. The method of claim 12, wherein the second event indicative of a power outage comprises a mobile device no longer receiving power through a charger.

16. The method of claim 12, wherein the selected length of time is selected from a group consisting of: 1 second, 2 seconds, 3 seconds, 4 seconds, and 5 seconds.

17. The method of claim 12, wherein the at least one illumination device is a first illumination device, and wherein the at least one power outage response comprises acts of:
selecting a second illumination device having at least some power reserve; and
using the power reserve of the second illumination device to turn on the second illumination device.

18. The method of claim 17, wherein the act of selecting the second illumination device comprises:
comparing an amount of power reserve of the second illumination device and an amount of power reserve of a third illumination device; and
selecting the second illumination device in response to determining that the second illumination device has more power reserve than the third illumination device.

19. The method of claim 17, wherein using the power reserve to turn on the second illumination device comprises dimming a brightness of the second illumination device.

20. The method of claim 17, wherein the second illumination device is the first illumination device.

21. The method of claim 17, further comprising acts of:
monitoring the power reserve of the second illumination device; and
in response to detecting that the power reserve of the second illumination device has fallen below a selected threshold, selecting a third illumination device having at least some power reserve; and
using the power reserve of the third illumination device to turn on the third illumination device.

22. At least one computer-readable medium having stored thereon instructions which, when executed by at least one processor, cause the at least one processor to perform a method for detecting and responding to a power outage, the method comprising acts of:
detecting at least one first event indicative of a power outage, the at least one first event comprising at least one illumination device losing power;
detecting at least one second event indicative of a power outage;
determining whether the at least one first event and the at least one second event are no more than a selected length of time apart from each other; and
in response to determining that the at least one first event and the at least one second event are no more than the selected length of time apart from each other, initiating at least one power outage response.

23. A system comprising at least one processor configured to perform a method for detecting and responding to a power outage, the method comprising acts of:
detecting at least one first event indicative of a power outage, the at least one first event comprising at least one illumination device losing power;
detecting at least one second event indicative of a power outage;
determining whether the at least one first event and the at least one second event are no more than a selected length of time apart from each other; and
in response to determining that the at least one first event and the at least one second event are no more than the selected length of time apart from each other, initiating at least one power outage response.

24. A method for detecting and responding to a potential intrusion, comprising acts of:
detecting at least one event indicative of a potential intrusion; and
in response to detecting the at least one event indicative of a potential intrusion, initiating a response, the response comprising turning on a first light, a second light, and a third light in sequence.

25. The method of claim 24, wherein the act of detecting at least one event indicative of a potential intrusion comprises acts of:
using a microphone to capture at least one audio signal; and
analyzing the at least one audio signal to detect a sound pattern indicative of a potential intrusion.

26. The method of claim 25, wherein the sound pattern is selected from a group consisting of:
doorbell ringing, knocking on a door, and glass breakage.

27. The method of claim 24, wherein the first light is a light in a bedroom, the second light is a light in a hallway, and the third light is a light in an entryway.

28. The method of claim 24, wherein a first delay between turning on the first light and turning on the second light and a second delay between turning on the second light and turning on the third light are randomly selected.

29. The method of claim 24, wherein the response further comprises turning off the first, second, and third lights in reverse order after the first, second, and third lights have been turned on.

30. The method of claim 24, wherein the response further comprises an audible response.

31. The method of claim 30, wherein the audible response comprises an alarm sound.

32. The method of claim 30, wherein the audible response comprises a recorded audio.

33. At least one computer-readable medium having stored thereon instructions which, when executed by at least one processor, cause the at least one processor to perform a method for detecting and responding to a potential intrusion, the method comprising acts of:
detecting at least one event indicative of a potential intrusion; and
in response to detecting the at least one event indicative of a potential intrusion, initiating a response, the response comprising turning on a first light, a second light, and a third light in sequence.

34. A system comprising at least one processor configured to perform a method for detecting and responding to a potential intrusion, the method comprising acts of:
detecting at least one event indicative of a potential intrusion; and
in response to detecting the at least one event indicative of a potential intrusion, initiating a response, the response comprising turning on a first light, a second light, and a third light in sequence.
